(19) United States
(12) Patent Application Publication
(10) Pub. No.: US 2021/0278302 A1
(43) Pub. Date: Sep. 9, 2021

(54) Sensor Device for a Vehicle, in Particular a Motor Vehicle

(71) Applicant: Robert Bosch GmbH, Stuttgart (DE)

(72) Inventors: Marlon Ramon Ewert, Untergruppenbach (DE); Daniel Schoenfeld, Abstatt (DE)

(21) Appl. No.: 16/341,271

(22) PCT Filed: Oct. 10, 2017
(86) PCT No.: PCT/EP2017/075796

§ 371 Date: Apr. 11, 2019

(30) Foreign Application Priority Data
Oct. 14, 2016 (DE) 10 2016 220 032.1

(51) Int. Cl. G01L 19/00; G01P 1/02; G01P 15/08

(52) U.S. Cl. CPC G01L 19/0061; G01P 15/08; G01P 1/023

(57) ABSTRACT

A sensor device for a vehicle, in particular a motor vehicle, includes at least one sensor module and at least one connecting line connected to the sensor module for making electrical contact with the sensor module. The connecting line is formed as a conductor film, on which a plurality of different sensor modules are arranged and are housed by respectively one or a common encapsulation encompassing the conductor film, at least in some sections.

The invention relates to a sensor device for a vehicle, in particular a motor vehicle, comprising at least one sensor module and at least one connection line, which is connected to the sensor module, for making electrical contact with the sensor module.

The invention further relates to a body component of a vehicle comprising a sensor device of this kind.

The invention furthermore relates to a method for producing a corresponding sensor device or a corresponding body component.

### PRIOR ART

Sensor devices of the kind mentioned in the introductory part are known from the prior art. In order to increase the safety of occupants and other road users, it is known to provide safety devices on the vehicle, which safety devices protect the occupants and/or other road users, such as pedestrians for example, from injury in the event of an accident. Known safety devices include, in particular, airbag devices, belt tensioners and the like. In this case, the safety devices are actuated depending on sensor data from sensor devices which detect a collision, for example, with the further road user, in particular a pedestrian. Systems which have two or more acceleration sensors and/or a pressure hose-based system are known for detecting accidents involving pedestrians. These systems are then arranged, for example, in a bumper of the vehicle in order to detect the collision of the vehicle with an object in the surrounding area.

Currently, sensor devices which are arranged on the B, C or D pillar of the vehicle, in particular comprising at least one acceleration sensor, or in the vehicle door, in particular comprising at least one pressure sensor, are used for detecting collisions on a vehicle longitudinal side. Currently, acceleration sensors, which are located, for example, in the central controller and/or along a flexible crossmember of the vehicle, are used for identifying collisions with objects in the front region. The signals which are output by the sensors are further processed by algorithms of a controller, in particular of an airbag controller, in order to make a decision as to whether to trip the respective safety device of the vehicle.

The sensors are usually fastened to a body part of the vehicle, such as to the bumper or a door panel for example, as a sensor module having its own housing and a connection line for making electrical contact. A screw or clip connection is often provided for fastening purposes. Electrical contact is often also made by means of a plug which is fitted to a cable harness. In principle, it is also known to use, for the purpose of making electrical contact with electronic components, a conductor foil which carries one or more electrical conductor tracks on at least one or between at least two carrier foils and is of flexible design. Owing to the, in particular, flat structure of the conductor foil, said conductor foil can be integrated into existing structures in an installation space-saving manner.

### DISCLOSURE OF THE INVENTION

The sensor device according to the invention having the features of claim 1 has the advantage that a compact and easy-to-handle sensor device is provided, said sensor device advantageously being able to be integrated into the vehicle and facilitating positioning and actuation of a plurality of sensor modules. According to the invention, provision is made, to this end, for a plurality of different sensor modules, that is to say sensor modules which at least have different sensors, to be arranged on the connection line, which is designed as a conductor foil, and to be enclosed by in each case one encapsulation which surrounds the conductor foil at least in sections. In this way, the sensor modules are held on the conductor foil by the encapsulation in a simple manner. In particular, the distances between adjacent sensor modules are already defined before mounting, as a result of which the actual mounting can be carried out in a rapid and nevertheless precise manner. Each sensor module is electrically connected to at least one electrical conductor track of the conductor foil. This can be done, for example, during production by soldering or making physical contact. In particular, the conductor foil has contact sections in which the one or the plurality of conductor tracks has/have a widened or enlarged contact area in comparison to the remaining profile of the conductor tracks through the conductor foil, so that simple electrical contact-making with the sensor module is ensured at this point. Sensor devices of this kind can preferably be arranged in the vehicle door, but can also be arranged, for example, in a bumper, in one of the vertical pillars or else in/on a vehicle seat of the vehicle. The conductor foil preferably has an adhesive on one side, by means of which adhesive the conductor foil can be fastened or at least premounted in a simple manner on a body element, for example on a panel element. Therefore, the conductor foil is preferably of multi-layered construction and has, in particular, an adhesive layer which is preferably covered by a removable protective layer before assembly. The conductor foil preferably has a two-wire line for making contact with the sensors by way of a peripheral sensor interface 5 (PSI5). Owing to the two-wire line of the conductor foil and contact being made with the sensors by a peripheral sensor interface 5 according to the PSI5 protocol, parallel operation of the sensors by means of a BUS system is possible, as a result of which the sensor device provides improved performance on account of the simultaneous signal transmission and evaluation, so that two independent measurement values of the two sensors of the sensor modules are available at a measurement point and can be checked for plausibility with respect to one another. In particular, the sensors of the sensor modules are designed as acceleration sensors. However, in addition to a parallel BUS mode, it is also conceivable to actuate the sensors using a universal BUS mode or a daisy chain BUS mode.

According to a preferred embodiment of the invention, provision is made for one of the sensor modules to have an acceleration sensor and another of the sensor modules to have a pressure sensor. Therefore, different sensors, which are used for detecting an accident in particular, are advantageously arranged on a conductor foil and can be mounted as a unit.

Furthermore, provision is preferably made for the respective encapsulation to have at least one fastening means for fastening the sensor module to a body part of the vehicle. The fastening means may be, for example, a latching means or a clamping means which interacts with a corresponding mating means of the body part of the vehicle in order to, in particular releasably, fasten the sensor module to the body part. The encapsulation is designed, for example, in such a way that the housing which is formed by the encapsulation has plug-in receptacles and/or plug-in projections which interact with corresponding plug-in projections and, respectively, plug-in receptacles of the body part for the purpose of fastening the sensor module. In particular, the fastening means are of elastically deformable design at least in regions, in order to allow the sensor module to be latched or clipped to the body part. Furthermore, provision is preferably made for the encapsulation to be at least partially formed together with the body part. In this way, the sensor device is an integral constituent part of the body part and is also taken into account as early as during production of the body part. As a result, although the ability to exchange the sensor device itself is made more difficult, production of the body part with the sensor function is made easier. According to a preferred development of the invention, provision is made for only two different sensor modules as described above to be arranged on the conductor foil. As a result, parallel operation is reliably ensured and the sensor device is rendered simple and cost-effective.

The encapsulation is preferably of elastically deformable design. This ensures that the respective sensor module is elastically deformable overall, in order to allow the sensor module to be subsequently integrally formed on a body part. Simple mounting of the respective sensor module or of the sensor device with an accurate fit is ensured in this way.

The respective sensor module expediently has a carrier on which the pressure sensor or the acceleration sensor is arranged. This means that the acceleration sensor is arranged on one carrier and the pressure sensor is arranged on the other carrier. The carrier is designed, in particular, as a so-called interposer which has electrical conductor tracks which lead to separation of electrical contacts. For example, first ends of the conductor tracks, which are associated with the respective sensor, are arranged more closely to one another than the other ends of the conductor tracks which make contact with conductor tracks of the conductor foil. This ensures that secure contact is made with the acceleration sensor and, at the same time, an undesired short circuit, in particular in the contact-making region to the conductor foil, is prevented in a simple manner. The acceleration sensor is preferably already mounted for premounting on the carrier. In this case, the acceleration sensor can be mounted on the carrier in the conventional manner.

According to an alternative embodiment of the invention, provision is preferably made for the sensor modules to have a common carrier on which the acceleration sensor and the pressure sensor are arranged. This ensures a particularly compact embodiment of the sensor device which also saves material, as a result of which the production costs are further reduced.

Furthermore, provision is preferably made for the carrier to be of flexible design. In particular, matching of the shape of the respective sensor module itself to a body part which has, for example, a curvature, as is customary in the case of bumpers for example, is reliably ensured in this way. In particular, the electronic/electrical components of the acceleration sensor and/or pressure sensor are preferably likewise designed such that they can be deformed without damage. In particular, to this end, integrated circuits for example are designed to be so thin that they are elastically deformable.

According to a preferred development of the invention, provision is made for the conductor foil to be of strip-like design and have at least one elastically and/or plastically deformable carrier foil and at least one conductor track which is elastically and/or plastically deformable together with the carrier foil.

Therefore, the conductor foil extends in the form of a strip or in the form of a tape and is provided with the sensor modules along its profile, as described above. Owing to the elastically and/or plastically deformable carrier foil(s) and conductor track(s), insertion and matching of the conductor foil to the respective vehicle body is rendered possible in a simple manner.

The body component according to the invention having the features of claim 9 is distinguished by a body part and at least one sensor device which is fastened to the body part and designed according to the invention. This results in the abovementioned advantages. In particular, provision is made for the sensor device to be designed such that it is integrated into the body component. The body component is preferably designed as an encapsulation of the sensor device at least in sections. In particular, the body component forms an additional or the abovementioned enclosure for the respective sensor module of the sensor device.

The method according to the invention for producing the sensor device as has been described above or of the above-described body component is distinguished by the features of claim 11. Here, provision is made initially for the same sensor modules to be arranged on the connection line which is designed as a conductor foil, and then for the conductor foil and the respective sensor module to be encapsulated in such a way that the respective sensor module is enclosed by an encapsulation which also surrounds the conductor foil at least in sections. This results in the abovementioned advantages.

Further advantages and preferred features and combinations of features can be found, in particular, in the above description and also in the claims.

The invention will be explained in more detail below with reference to the drawing, in which

FIG. 1 shows a simplified sectional illustration of a sensor device,

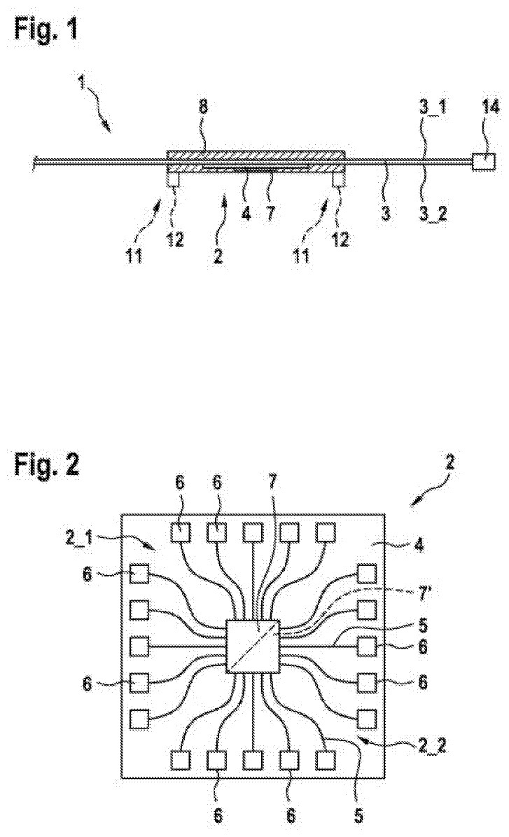

FIG. 2 shows a simplified plan view of a sensor module of the sensor device, and

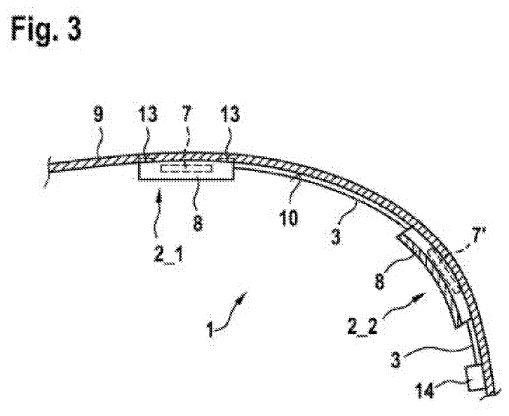

FIG. 3 shows a simplified illustration of a body component of a motor vehicle.

FIG. 1 shows a simplified longitudinal sectional illustration of a sensor device 1 which has a sensor module 2 and a conductor foil 3. The conductor foil 3 is of strip- or tape-like design and is formed, in particular, from at least one carrier foil 3_1 on which two electrically conductive conductor tracks 3_2 are arranged. The conductor foil 3 is manufactured, in particular, in a known manner.

FIG. 2 shows a simplified plan view of the sensor module 2. The sensor module 2 has a carrier 4 which is manufactured from an electrically non-conductive and elastically deformable material. A plurality of conductor tracks 5 which run in a star-shaped manner from the outside to the inside, or the other way around, are arranged on the carrier 4. A plurality of electrically conductive contact points 6 are arranged at the outer edges of the carrier 4, wherein only some conductor tracks 5 and contact points 6 are provided with reference symbols here for reasons of clarity. The contact points 6 are connected to in each case one end of one of the conductor tracks 5, for example are integrally formed with them. The conductor tracks 5 lead from the contact points 6 into the middle of the carrier 4 where an acceleration sensor 7 and/or a pressure sensor 7′ are/is arranged and are/is electrically contacted by the free ends of the conductor tracks 5. For the purpose of making contact with the respective sensor, corresponding contact points are provided at the other ends of the conductor track 5, said contact points not being shown in FIG. 2. The carrier 4 therefore forms a so-called interposer together with the conductor tracks 5 and the respective contact points 6, said interposer separating the electrical contacts of the acceleration sensor 7 or pressure sensor 7′ amongst the contact points 6 which, in comparison to the contact points of the acceleration sensor 7/pressure sensor 7′, are arranged further apart and therefore can be contacted more easily. In the present case, the contact points 6 are electrically connected to the conductor tracks 3_2 of the conductor foil 3.

The carrier 4 is placed on the conductor foil 3 in such a way that the contact points 6 are in physical contact with the corresponding conductor tracks 3_2 of the conductor foil 3, in order to establish an electrical connection. The contact points 6 are optionally welded or soldered to the respective conductor tracks 3_2 in order to ensure permanent electrical contact.

The sensor module 2 which rests on the conductor foil 3 is enclosed by an encapsulation 8 which also surrounds the conductor foil 3 in sections. In this way, firstly the sensor module 2 itself is enclosed and protected against external influences by the encapsulation 8 and secondly the sensor module 2 is fastened to the conductor foil 3 in a simple manner by said encapsulation. In this respect, the sensor module 2 and the conductor foil 3 former an advantageous unit which allows simple arrangement and fastening of the sensor device 1 to a body part.

According to the exemplary embodiment shown in FIG. 3, two sensor modules 2_1 and 2_2 of the kind described with respect to the sensor module 2 are arranged on the conductor foil 3 and connected to the conductor foil 3 by a respective encapsulation 8. The sensor device 1 is connected, in particular, to a controller, not illustrated here, by the conductor foil 3, said controller actuating a safety device of a vehicle, such as an airbag device or a belt tensioner for example, the sensor data detected or provided by the sensor 7/7′.

The sensor device 1 comprises two sensor modules 2_1 and 2_2 of this kind, wherein in the present case one sensor module 2_1 has the acceleration sensor 7 and the other sensor module 2_2 has the pressure sensor 7′. The sensor modules 2_1 and 2_2 therefore each have their own carrier 4 with corresponding conductor tracks 5 for making contact with the respective sensor and are connected to the conductor foil 3 as described above.

As an alternative, provision is made, according to a further exemplary embodiment which is shown by dashed lines in FIG. 2, for the acceleration sensor 7 and the pressure sensor 7′ to be arranged on a common carrier 4. In this case, a single encapsulation 8 for enclosing and locking the sensor modules 2_1 and 2_2 on the conductor foil 3 suffices.

For the purpose of arrangement in the vehicle, the sensor device 1 can be fastened to a body part in a simple manner. To this end, FIG. 3 shows, in one exemplary embodiment, a sectional illustration of a body part 9 of a motor vehicle, wherein the body part 9 represents a bumper of the motor vehicle. The body part 9 is of curved design at least in sections, wherein the sensor device 1 is arranged on the inner side of said body part, which inner side has, in the present exemplary embodiment, the two sensor modules 2_1, 2_2 which are arranged on the conductor foil 3 as described above. Since the sensor modules 2_1, 2_2 are respectively enclosed together with the conductor foil 3 by the encapsulation 8, the distance of said sensor modules from one another on the conductor foil 3 is prespecified, as a result of which mounting of the sensor device 1 comprising a plurality of sensor modules 2 on the body part 9 is simplified. Owing to the flexible configuration of the conductor foil 3, it can be guided along the inner side 10 of the curved body part 9 in a simple manner, so that it is arranged/can be arranged on the body part 9 in an installation space-saving and optimum manner.

According to a further exemplary embodiment which is likewise shown in FIG. 3, the sensor device 1 is designed in a manner integrated into the body part 9. In this case, the body part 9 is, in particular, a panel element, such as a door element or a panel element of the B pillar for example. To this end, the body part 9 itself forms part of the encapsulation 8 of the sensor module 2_2 which is shown, by way of example, in FIG. 3. Therefore, the body part 9 can also be shaped together with the encapsulation 8, as a result of which a particularly compact and easy-to-handle unit is produced. It is also conceivable for the respective sensor module 2_2 to be subsequently surrounded by an additional encapsulation 8 of the body part 9 and held on said body part in this way. The two sensor modules 2_1, 2_2 are preferably fastened to the body part 9 according to the further exemplary embodiment.

It goes without saying that more than two sensor modules 2 can also be arranged on the conductor foil 3. Therefore, the body part 9, together with the sensor device 1, forms an advantageous body component which is already provided with a pressure sensor system and/or acceleration sensor system for actuating safety devices of the motor vehicle.

A connection plug 14, which is likewise produced by an encapsulation of the conductor foil 3, is arranged at one free end of the conductor foil 3. The connection plug 14 provides the connection to the controller, already mentioned above, in particular airbag controller, of the vehicle. By way off the plug 14, the sensor device 1 can be connected, in particular, to a peripheral sensor interface 5 which constitutes a digital interface according to the PSI5 protocol for sensors. In this case, the sensor interface 5 is based on the two-wire line and is already used in automotive electronics for connecting external sensors to electronic controllers. In this case, the interface supports point-to-point and BUS configurations with asynchronous and synchronous communication. In the present case, provision is made for the sensor device to be operated by a parallel BUS configuration, so that the two acceleration sensors 7 can be operated in parallel with one another. As a result, two items of measurement data are obtained at the same time and can be checked for plausibility with respect to one another.

Owing to the flexibility of the sensor device 1, the sensor modules 2_1 and 2_2 can, as illustrated in FIG. 3, be arranged one above the other or, if required, also next to one another on the body part 9

The integration of the sensor device 1 into the body part 9 provides the advantage of concealed installation which prevents intervention by the end user in the electronic system. The system security is increased as a result. On account of the low thickness of the sensor device 1, the mechanical structural strength of the body part 9 is not influenced or hardly influenced by the integration of the sensor device 1 into the body part 9. The sensor function of the sensor device 1 as an integral stand part of the body part 9 can be combined with further functions which are directly integrated in the end component, such as an integrated electrical energy store, heating wires or induction coils for example, as a result of which multifunctionality of the body component is implemented with conductive construction.

In particular, owing to the integrated design of the sensor device 1, high-precision positioning and orientation of the sensor on the conductor foil or on the body part 9 is achieved, as a result of which the number of steps for production and subsequent testing of the functional capability can be reduced.

The production of the sensor device 1 using foil-based back-molding technology or encapsulation technology or alternatively by foil-based integration into the body part 9 is cost-effective and not very time-consuming. For the purpose of mounting the sensor device 1, provision can also be made for the encapsulation 8 to have in each case one or more fastening means 11 which bear against the body part 9 for the purpose of fastening the respective sensor module 2. Therefore, provision is made, according to the exemplary embodiment illustrated using dashed lines in FIG. 1, for the fastening means 11 to be designed as plug-in projections 12 which can be plugged into corresponding plug-in receptacles 13 of the body part 9. The plug-in projections 12 and plug-in receptacles 13 are expediently designed to form an interference fit in each case, so that the respective sensor module 2 can be easily mounted, or at least premounted, on the body part 9. It is also conceivable to design the fastening means as latching means in order to allow the respective sensor module 2 to be latched to the body part in an interlocking manner.

In addition, the production costs can be further reduced here by virtue of a 2R2 production line being used, or open semiconductors being mounted directly, with the aim of reducing foil surface area. The production costs are also reduced as a result of the simple mounting of the sensor device 1 on the vehicle or on the body part 9, for example by direct integration of the sensor device 1 into the body part 9 as a fiber-reinforced plastic structure in the case of a molding process, in particular in the case of an LCM process (LCM=liquid composite molding).

Owing to the technique used, the sensors 7 and 7′ of the sensor modules 2 are directly integrated into or arranged on the body part 9, in particular into a bumper, in a simple manner. It goes without saying that the body part 9 may also be a door panel or, for example, an A, B, C or D pillar of the motor vehicle. It is also conceivable to arrange the sensor device 1 in a vehicle seat. Simple electrical connections of the components of the sensor device 1 can be realized by virtue of using direct plug-in techniques. Furthermore, owing to the advantageous housing of the sensor modules 2, a customer-specific plug-in connector can be directly attached to the conductor foil 3. Owing to the flexible configuration of the sensor device 1, subsequent deformation of the sensor device 1, as already shown using the example of FIG. 3, is also possible. Complex structures and geometries, to the extent of stacking a plurality of sensor modules one on the other, can be produced using a suitable falling technique. If the conductor foil 3 has more than two layers of carrier foil and conductor tracks, it is also possible to realize complex electrical circuits by means of a multilayer structure. The carrier material of the conductor foil 3 and optionally also the carrier of the respective sensor module 2 are preferably manufactured from an elastically and plastically deformable material, so that the carrier foil 3 and, if necessary, the carrier 4 can be extended or stretched and deformed in all directions. In particular, owing to the deformability of the carrier 4, it is possible to design the sensor module 2 itself in an adapted manner as an insert part, so that it fits into or can be placed on a three-dimensionally shaped body part with dimensional accuracy.

1. A sensor device for a vehicle, comprising:
at least one sensor module; and
at least one connection line connected to the at least one sensor module and configured to make electrical contact with the sensor module, the at least one connection line configured as a conductor foil,
wherein a plurality of different sensor modules of the at least one sensor module are each arranged within and enclosed by one common encapsulation which surrounds the conductor foil at least in sections.

2. The sensor device as claimed in claim 1, wherein a first sensor module of the at least one sensor module includes an acceleration sensor and a second sensor module of the at least one sensor module has a pressure sensor.

3. The sensor device as claimed in claim 1, wherein the common encapsulation includes at least one fastening element configured to fasten the at least one sensor module to a body part of the vehicle.

4. The sensor device as claimed in claim 1, wherein the common encapsulation is configured to be elastically deformable.

5. The sensor device as claimed in claim 2, wherein:
the at least one sensor module includes a carrier; and
at least one of the acceleration sensor and the pressure sensor is arranged on the carrier.

6. The sensor device as claimed in claim 2, wherein:
the first sensor module and the second sensor module include a common carrier; and
the acceleration sensor and the pressure sensor are arranged on the common carrier.

7. The sensor device as claimed in claim 5, wherein the carrier is flexible.

8. The sensor device as claimed in claim 1, wherein:
the conductor foil is strip-like;
the conductor foil includes at least one elastically deformable and/or plastically deformable carrier foil; and
the conductor foil includes a two-wire line which is elastically deformable and/or plastically deformable together with the carrier foil.

9. A body component for a vehicle, comprising:
a body part; and
at least one sensor device fastened to the body part, the at least one sensor device including:
at least one sensor module; and
at least one connection line connected to the at least one sensor module and configured to make electrical contact with the sensor module, the at least one connection line configured as a conductor foil,
wherein a plurality of different sensor modules of the at least one sensor module are each arranged within and enclosed by one common encapsulation which surrounds the conductor foil at least in sections.

10. A method for producing a sensor device having at least one sensor module and at least one connection line configured as a conductor foil, the method comprising:
connecting the conductor foil to the at least one sensor module such that the conductor foil makes electrical contact with the at least one sensor module;
arranging a plurality of different sensor modules of the at least one sensor module on the conductor foil;
enclosing the plurality of different sensor modules by one common encapsulation; and
surrounding the conductor foil at least in sections with the common encapsulation.

11. The sensor device as claimed in claim 1, wherein the vehicle is a motor vehicle.
